(19) United States
(12) Patent Application Publication
(10) Pub. No.: US 2015/0317694 A1
(43) Pub. Date: Nov. 5, 2015

(54) CREDITING ECOMMERCE ENTITIES FOR CONVERSIONS

(71) Applicant: Google Inc., Mountain View, CA (US)

(72) Inventors: Justin Lewis, Marina del Rey, CA (US); Ruxandra Georgiana Paun, Santa Monica, CA (US)

(73) Assignee: Google Inc., Mountain View, CA (US)

(21) Appl. No.: 14/269,924

(22) Filed: May 5, 2014

(51) Int. Cl. G06Q 30/02

(52) U.S. Cl. CPC G06Q 30/0273

(57) ABSTRACT

Methods, systems, and apparatus include computer programs encoded on a computer-readable storage medium for crediting an entity for a conversion. A method includes: providing an interface to an entity; receiving transaction information from the entity through the interface; creating a token; providing the token to the entity; storing the transaction information in association with the token in a first log; receiving from the entity a user identifier associated with the transaction along with the token; associating the user identifier with the token in a second log; determining a linking between impressions and conversions including using the token to determine a relevant user identifier and transaction details, and using the determined relevant user identifier to locate prior impressions made to the user; and debiting a content sponsor associated with the prior impression, and crediting a publisher that published the impression and the entity, when a linking impression and conversion is located.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for crediting an entity for a conversion. The method includes: providing an interface that is externally exposed to an eCommerce entity, the interface being configured to receive transaction information associated with transactions by entities with the eCommerce entity that are known to a content serving system; receiving through the interface transaction information associated with a first transaction; creating a token; providing the token to the eCommerce entity; storing the transaction information in association with the token in a first log; receiving from the eCommerce entity a user identifier associated with the transaction along with the token; associating the user identifier with the token in a second log; determining a linking between impressions and conversions based on the token, the first log, and the second log including using the token to determine a relevant user identifier and transaction details, and using the determined relevant user identifier to locate prior impressions made to the user; and debiting a content sponsor associated with the prior impression and crediting a publisher that published the impression, and the eCommerce entity that provided the transaction information when a linking impression and conversion is located.

In general, another aspect of the subject matter described in this specification can be implemented in computer program products. A computer program product is tangibly embodied in a computer-readable storage device and comprises instructions. The instructions, when executed by a processor, cause the processor to: provide an interface that is externally exposed to an eCommerce entity, the interface being configured to receive transaction information associated with transactions by entities with the eCommerce entity that are known to a content serving system; receive through the interface transaction information associated with a first transaction; create a token; provide the token to the eCommerce entity; store the transaction information in association with the token in a first log; receive from the eCommerce entity a user identifier associated with the transaction along with the token; associate the user identifier with the token in a second log; determine a linking between impressions and conversions based on the token, the first log, and the second log including using the token to determine a relevant user identifier and transaction details, and using the determined relevant user identifier to locate prior impressions made to the user; and debit a content sponsor associated with the prior impression and crediting a publisher that published the impression, and the eCommerce entity that provided the transaction information when a linking impression and conversion is located.

In general, another aspect of the subject matter described in this specification can be implemented in systems. A system includes one or more processors and one or more memory elements including instructions. The instructions, when executed, cause the one or more processors to: provide an interface that is externally exposed to an eCommerce entity, the interface being configured to receive transaction information associated with transactions by entities with the eCommerce entity that are known to a content serving system; receive through the interface transaction information associated with a first transaction; create a token; provide the token to the eCommerce entity; store the transaction information in association with the token in a first log; receive from the eCommerce entity a user identifier associated with the transaction along with the token; associate the user identifier with the token in a second log; determine a linking between impressions and conversions based on the token, the first log, and the second log including using the token to determine a relevant user identifier and transaction details, and using the determined relevant user identifier to locate prior impressions made to the user; and debit a content sponsor associated with the prior impression and crediting a publisher that published the impression, and the eCommerce entity that provided the transaction information when a linking impression and conversion is located..

These and other implementations can each optionally include one or more of the following features. Providing the interface can include providing an API. The user identifier can be received as a result of an iFrame being generated as part of the transaction. The iFrame can be associated with a domain of the content serving system. Receiving the user identifier can include receiving a cookie responsive to an iFrame being presented in association with the transaction. Prior impressions for the relevant user identifier can be identified. One or more impressions of content that have been made prior to a time associated with the transaction to a user associated can be located using the relevant user identifier. Transaction information for the transaction can be identified based on the token and the first log. The one or more impressions and transaction information can be evaluated to determine that they are related. Evaluating the one or more impressions and transaction information can include determining a brand associated with the impression and determining that the brand is associated with products or services identified in the transaction information. Evaluating the one or more impressions and transaction information can include determining a brand associated with a product or service that is part of the transaction and locating one or more impressions that relate to the brand. A log of impressions can be provided. The log can include user identifier information for entities that were presented content, and information describing the presented content. The information describing the presented content can include brand information. Bids can be received from content sponsors for conversions based on an initial brand impression. The bids can be stored in an inventory. Requests for content can be received and brand impressions from the inventory can be served responsive to the received request without debiting a content sponsor associated with a respective brand impression until a subsequent conversion is determined to have occurred based on the determined linking.

Aspects of the invention can include none, one or more of the following advantages. A conversion associated with an impression of a brand content item can be tracked. Brand-related conversions associated with a content management system can be tracked without a user being logged in to the content management system. An entity can be credited for participating in conversion tracking.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 is a block diagram of an example system for presenting content.

FIGS. 3 and 4 are flowcharts of example processes for crediting an entity for a conversion.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

A content server can provide an interface to an entity (an eCommerce entity) and can receive transaction information through the interface. In response to receiving transaction information for a specific transaction, the content server can create a token, return the token to the entity, and store the transaction information in association with the token in a first log. Subsequently, the content server can receive a user identifier associated with the transaction and the token from the entity. The content server can associate the user identifier with the token in a second log. The content server can determine a linking between impressions and conversions based on the token, the first log, and the second log, such as by using the token to determine a relevant user identifier and transaction details, and using the determined relevant user identifier to locate prior impressions made to a user identified by the user identifier. The content server can debit a content sponsor associated with the prior impression and credit a publisher that published the impression and the entity that provided the transaction information.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

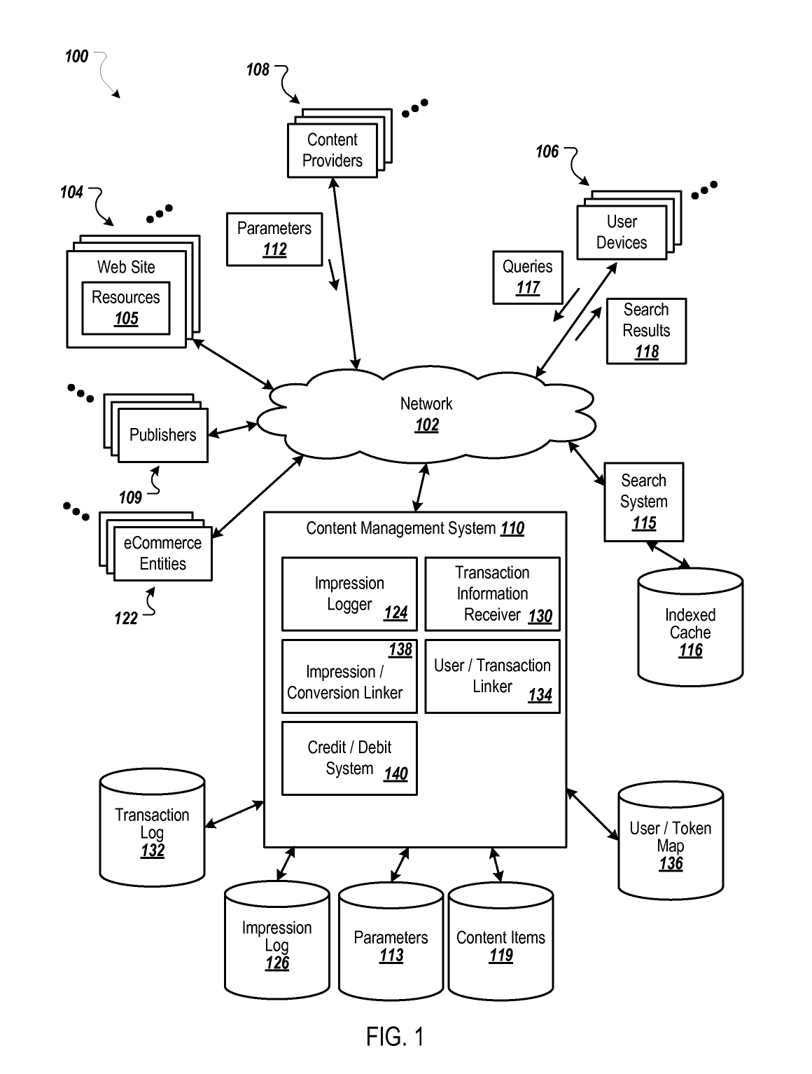

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices (e.g., access devices) 106, content providers 108, publishers 109, and a content management system 110. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 112 which define a content campaign. The content campaign can be created and activated for the content provider 108 according to the parameters 112 specified by the content provider 108. The campaign parameters 112 can be stored in a campaign database 113. Campaign parameters 112 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms, can include, for example, one or more keywords. The selection terms can be used in evaluating when to serve content items in response to received requests for content.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 and location information associated with the user device 106 can be received with the request for content.

Based, for example, on data included in the request for content, the content management system 110 can select (e.g., from a content items data store 119) content items that are eligible to be provided in response to the request. The content management system 110 can, for example, select a content item having characteristics matching the characteristics of a given slot. As another example, content items having selection criteria (e.g., keywords) that match resource keywords in the search query 117 or keywords included in the search results 118 may be selected as eligible content items by the content management system 110. As yet another example, the content management system 110 can identify a content item in the content items datastore 119 that is associated with a keyword that matches a keyword included in a user profile associated with the requesting user device 106.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). A quality score can be determined, for example, based on a quality of match between, for example, a keyword associated with a content item and keywords associated with a resource that includes the slot associated with the request. As another example, a quality score can be determined based on a quality of match between a keyword associated with a content item and keywords included in a user device profile associated with the requesting user device 106. One or more selected content items can be provided to the user device 106 in association with providing an associated resource 105 or search results 118. The provided content item(s) can be presented on the user device 106, in one or more respective slots.

Some of the content providers 108 can configure one or more brand campaigns that include one or more brand content items. In some implementations, a brand campaign is characterized as one that includes information related to a brand, but does not solicit specific user interaction. The content providers 108 may desire to track conversions that can be attributed to a brand campaign. A user of a user device 106 can, for example, execute a transaction (e.g., purchase a product or service) related to the brand, such as from an eCommerce entity 122. In some implementations, the user device might not be logged into the content management system 110 when the transaction is performed. As described in more detail below, the content management system 110 and the eCommerce entity 122 can be configured to the match the conversion with a prior presentation of content from a brand campaign.

What constitutes a conversion may vary from case to case and can be determined in a variety of ways. For example, a conversion may occur when a user clicks on a content item, is referred to a web page, and then consummates a purchase before leaving that web page. Actions that constitute a conversion can be specified by each content provider 108 on a content provider by content provider basis. For example, each content provider 108 can select, as a conversion, one or more measurable/observable user actions such as, for example, downloading a white paper, installing a software item, registering for a subscription, spending at least a predetermined amount of time on a website or web page, or registering on a website. Other actions that constitute a conversion can also be used. A conversion can be defined to occur upon the occurrence of a final action that is used to define the conversion. For example, if a user visiting five web pages defines a conversion, the conversion occurs upon the user's request for the fifth web page, and the four page views that occurred prior to the request for the fifth web page are considered to have occurred prior to the conversion.

An impression logger 124 can log impressions of content items on user devices 106. For example, the impression logger 124 can store impression information in an impression log 126. Information in the impression log can include, for example, impression information keyed by user device identifiers. Some impressions presented on user devices 106 can be brand impressions. A user who views a brand impression may decide to purchase a product or service associated with the brand. For example, an eCommerce entity 122 can sell products and/or services associated with a plurality of brands including a brand associated with the content provider 108 who provided the brand impression. A user of a user device 106 can purchase a product or service associated with the brand from a website of an eCommerce entity 122.

A transaction information receiver 130 can receive transaction information from the eCommerce entity 122, such as from an API (Application Programming Interface). The content management system 110 can expose the API to the eCommerce entity 128 and the transaction information receiver 130 can receive transaction information using the API. The transaction information can include, for example, an identifier of the eCommerce entity 122, price amount(s), transaction date, and information about purchased products and/or services. The transaction information receiver 130 can create a token to be associated with the transaction information and can return the token to the eCommerce entity 122 through the API. In some implementations, the transaction information receiver 130 can store the transaction information in a transaction log 132, keyed by the token.

A user/transaction linker 134 can associate a user/user device 106 with a transaction (e.g., linking a user that made a purchase with particular purchased items). For example, a resource associated with the eCommerce entity 122 can include an iFrame or other component that is loaded after a conversion is completed. A URL (Uniform Resource Locator) of the iFrame can be amended to include the token. The token can be associated with the iFrame in other ways. The user/transaction linker 134 can receive, using the iFrame, the user/user device identifier along with the token and can store a mapping of the user/user device identifier to the token in a user/token map 136.

An impression/conversion linker 138 can identify a relationship between an impression and a conversion. For example, the impression/conversion linker 138 can determine which transactions in the transaction log 132 correspond to an impression in the impression log 126. The impression/conversion linker 138 can identify relationships using, at least in part, entries in the user/token map 136. Determining linking impressions and conversions is described in more detail below.

A credit/debit system 140 can issue credits and/or debits to entities that participate in the conversion transaction. For example, a publisher 109 who published a resource on which the impression occurred can be credited. The eCommerce entity 122 with whom the transaction occurred (and who reported the conversion) can be credited, such as with an electronic funds credit or with a credit that can be used to purchase services offered by the content management system 110 (e.g., the eCommerce entity 122 can use a credit to create a content campaign managed by the content management system 110). The content provider 108 can be debited for the impression. In some implementations, the credit/debit system 140 debits the content provider 108 based at least in part on a conversion basis, wherein the content provider 108 is not charged or is not completely charged until a subsequent conversion is determined to have occurred (e.g., based on an impression/conversion linking as determined by the impression/conversion linker 138).

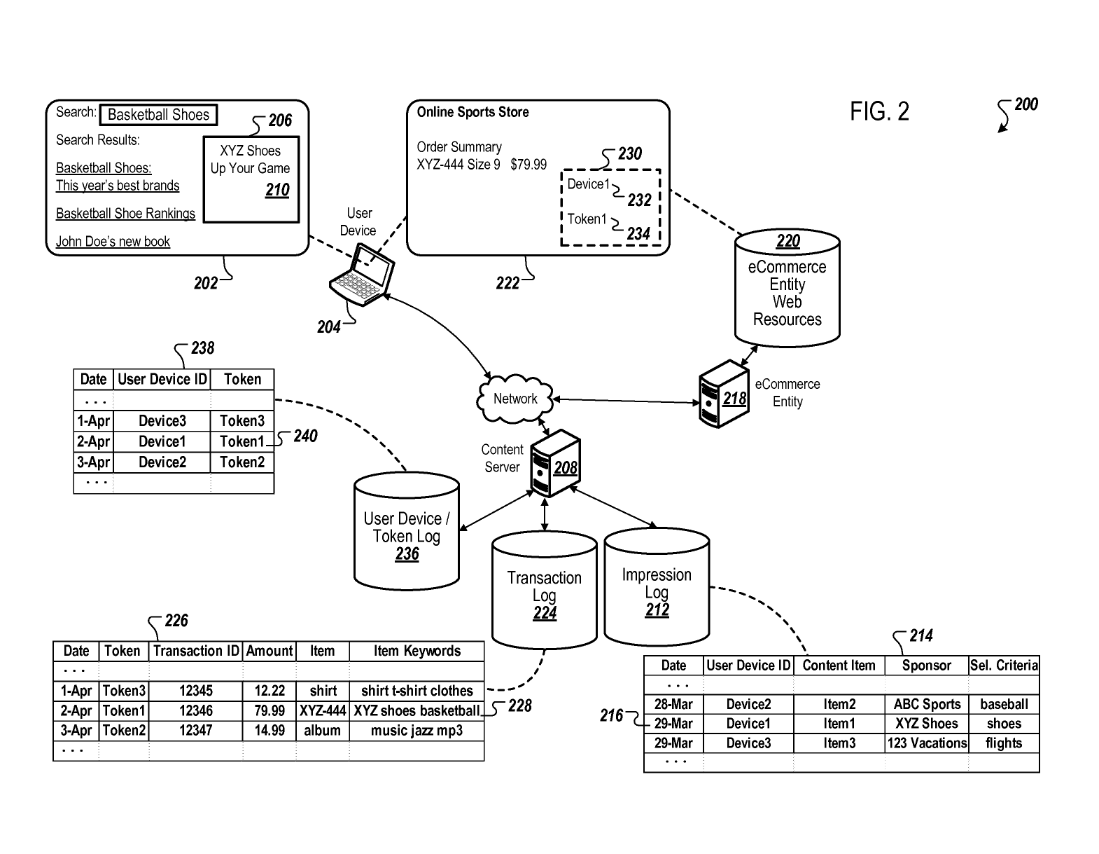

FIG. 2 is a block diagram of an example system 200 for presenting content. A web page 202 is presented on a user device 204. The web page 202 includes a content slot 206. A content request for a content item to present in the content slot 206 can be sent to a content server 208. The content server 208 can select a content item and provide the content item to the user device 204, for presentation in the content slot 206, as illustrated by a presented content item 210. The content item 210 in this example is a brand content item provided by an XYZ Shoes content sponsor.

The content server 208 can log information associated with the impression of the content item 210, such as in an impression log 212. For example, as shown in example log data 214, a row 216 associated with the impression of the content item 210 can be stored, along with other rows associated with other impressions. The row 216 includes an impression date of March 29, a device identifier (e.g. “Device1”) for the user device 204, a content item identifier (e.g., “Item1”) for the content item 210, a content sponsor identifier (e.g., “XYZ Shoes”) which identifies the content sponsor of the content item 210, and selection criteria (e.g., “shoes”) associated with the content request for the content slot 206. Other information can be stored in the row 216.

Subsequent to the impression of the content item 210 on the user device 204, the user of the user device 204 can use the user device 204 (or another device) to view one or more web pages provided by an eCommerce entity 218 (e.g., an online retailer). The eCommerce entity 218 can sell products and/or services associated with the content sponsor (e.g., XYZ Shoes) of the content item 210 and products or services associated with other entities. The user of the user device 204 can, for example, perform an interaction that is associated with a conversion event (e.g., purchase a product associated with the content sponsor using one or more web pages provided by the eCommerce entity 218). The eCommerce entity 218 can provide, for example, one or more web pages or other resources from a web resources repository 220. For example, the provided web pages can include an order summary web page 222 which can be provided to and presented on the user device 204 after the user of the user device 204 has completed a purchase from the eCommerce entity 218.

The content server 208 can expose an interface, such as an API, to the eCommerce entity 218. The eCommerce entity 218 can use the interface to provide information about transactions to the content server 208. The transaction information can include, for example, a transaction date/time, a transaction amount, information describing purchased products or services, and/or other information. The eCommerce entity 218 can gather information, for example, from a transaction database accessible to the eCommerce entity 218 and/or from information gathered during the transaction. The content server 208 can receive the transaction information using the interface. In response to receiving the transaction information, the content server 208 can generate a token to be associated with a specific transaction and can provide the token to the eCommerce entity 218.

The content server 208 can store the transaction information in association with the token, such as in a transaction log 224. For example, as illustrated in example transaction log data 226, a row 228 can be stored. The row 228 includes a transaction date of April 2, a token (e.g., “Token1”), a transaction identifier (e.g., 123456 (in some implementations, the token serves as a transaction identifier)), a transaction amount (e.g., $79.99), an item-purchased identifier (e.g., XYZ-444), and item-purchased keywords (e.g., “XYZ shoes basketball”).

The content server 208 can receive from the eCommerce entity 218 a user/user device identifier associated with the transaction. For example, the eCommerce entity 218 can generate a web page component, such as an iFrame, as part of the transaction conducted with the user device 204. For example, an iFrame component 230 can be included in the order summary web page 222. The iFrame component 230 can, for example, be hidden (e.g., not visible to the user of the user device 204). The eCommerce entity 218 can include data in or otherwise associate data with the iFrame component 230. For example, a user/user device identifier 232 (e.g., “Device1”) and a token 234 received from the content server 208 (e.g., “Token1”) are associated with the iFrame component 230.

In some implementations, the iFrame component 230 is associated with a domain of the content server 208. The content server 208 can use (e.g., communicate with) the iFrame component 230 to retrieve the user/user device identifier 232 and the token 234. The content server 208 can store the user/user device identifier 232 in association with the token 234, such as in a user device/token log 236. In some implementations, example user device/token data 238 includes a row 240 which maps the user/user device identifier 232 (e.g., “Device1”) to the token 234 (e.g., “Token1”). Although the user device/token log 236 and the transaction log 224 are shown as different logs, in some implementations, data items shown in the user device/token log 236 and the transaction log 224 are stored in a same data structure.

The content server 208 can process the user device/token log 236, the transaction log 224, and the impression log 212 to determine a linking between an impression and a conversion. For example, the content server 208 can perform such processing on a periodic (e.g., daily) basis, or can perform such processing, for example, in response to receiving transaction information from an eCommerce entity such as the eCommerce entity 218. The content server 208 can determine a linking between impressions and conversions by using a respective token to determine a relevant user/user device identifier and transaction details, and using the determined relevant user/user device identifier to locate prior impressions presented on the user device.

For example, the content server 208 can, as part of processing the row 240, identify the row 228 as being associated with the row 240, such as based on both the row 240 and the row 228 each including a same token value (e.g., “Token1”). The content server 208 can determine that the transaction information included in the row 228, including a transaction date/time of April 2, is relevant transaction information that is associated with the user device identifier (e.g., “Device1”) stored in the row 228. The content server 208 can locate entries in the impression log 212 that represent impressions made on the user device with identifier of “Device1” that are prior to the relevant transaction date of April 2. For example, the row 216 can be located.

The content server 208 can evaluate the located impression(s) to determine whether one or more impressions are related to the transaction. For example, the content server 208 can determine a brand (e.g., XYZ shoes) associated with the impression and determine that the brand is associated with the relevant transaction information. For example, the content server 208 can determine a brand of “XYZ” that is associated with the content sponsor associated with the row 216 and can determine that the brand “XYZ” is associated with the relevant transaction information (e.g., based on the purchased item of “XYZ-444” and/or on the purchased item keyword of “XYZ”). Accordingly, the content server 208 can determine a linking between the impression associated with the row 216 and a conversion associated with the row 228. When such a linking is determined, the content server 208 can debit the content sponsor of the content item 210 (e.g., based on a bid associated with the content item 210). The content server 208 can credit the eCommerce entity 218 based on the determined linking

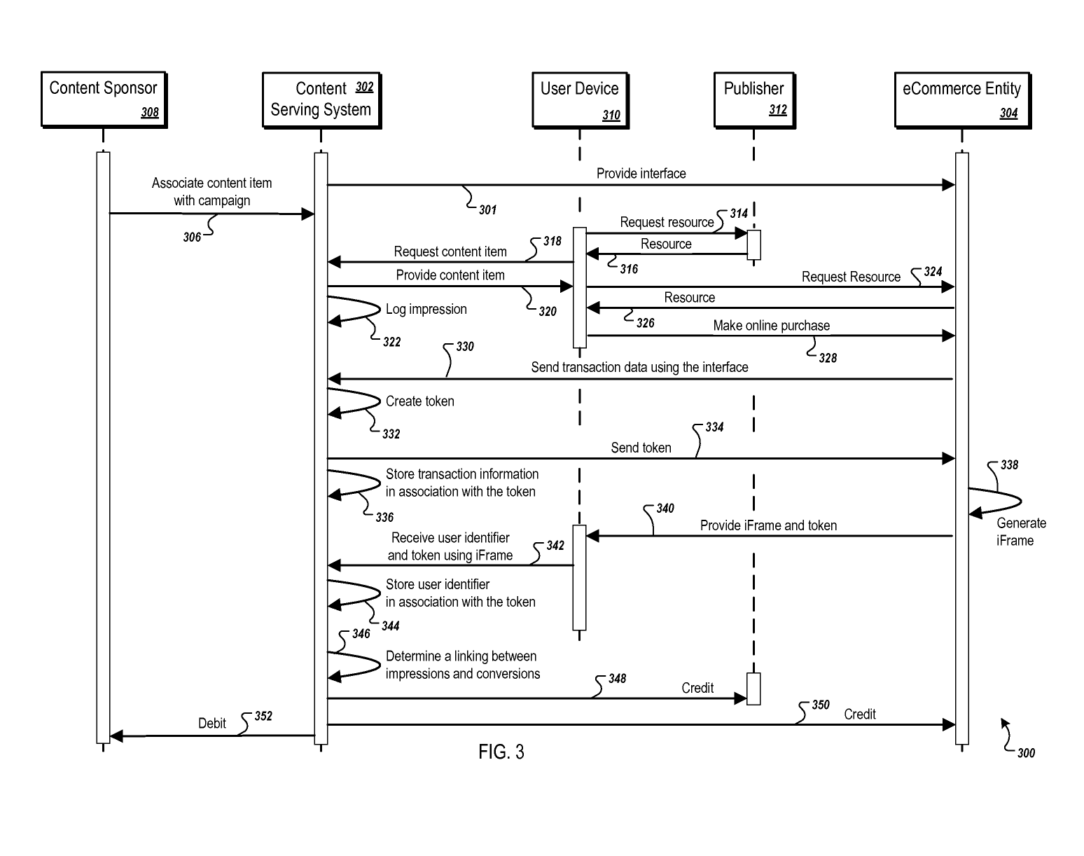

FIG. 3 is a flowchart of an example process 300 for crediting an entity for a conversion. Arrow 301 represents a content serving system 302 providing an interface to an eCommerce entity 304. For example, the interface can be externally exposed to the eCommerce entity 304 by the content serving system 302. As described below, the interface is configured to receive transaction information from the eCommerce entity 304.

As illustrated by arrow 306, a content sponsor 308 can associate a content item with a campaign that is managed by the content serving system 302. For example, selection criteria can be associated with the content item and/or the campaign. The content item can be provided to user devices in response to a request for content, such as for a content slot that is included in a publisher resource.

For example, a user device 310 can request a publisher resource from a publisher 312, as illustrated by arrow 314. The publisher resource can be, for example, a web page. The publisher 312 can provide the requested resource to the user device 310, as illustrated by arrow 316. The publisher resource can, as mentioned, include a content slot. When the publisher resource is presented on the user device 310, a content request for the content slot can be sent to the content serving system 302, as illustrated by arrow 318. In some implementations, the publisher 312, rather than the user device 310, sends a content request for the content slot. The content serving system 302 can select a content item to be provided in response to the request for content, such as the content item provided by the content sponsor 308. The selected content item can be provided to the user device 310, as illustrated by arrow 320, for presentation in the content slot. The content serving system 302 can log the impression of the content item (e.g., as illustrated by arrow 322), such as in an impression log.

Subsequent to the impression of the content item on the user device 310, the user of the user device 310 can visit a web page of the eCommerce entity 304. For example, arrow 324 illustrates the user device 310 requesting a resource (e.g., web page) from the eCommerce entity 304. The eCommerce entity can provide the requested resource (e.g., as illustrated by arrow 326). The user of the user device 310 can interact with one or more resources (e.g., web pages) of the eCommerce entity 304 to make an online purchase from the eCommerce entity 304 (e.g., as illustrated by arrow 328).

The eCommerce entity 304 can send transaction information related to the transaction (e.g., online purchase) to the content serving system 302 (e.g., as illustrated by arrow 330), using the interface provided by the content serving system 302. The content serving system 302, in response to receiving the transaction information, can create a token to be associated with the transaction information (e.g., as illustrated by arrow 332). The content serving system 302 can send the token to the eCommerce entity (e.g., as illustrated by arrow 334). The content serving system 302 can store the transaction information in association with the token, such as in a transaction log (e.g., as illustrated by arrow 336).

Upon receiving the token from the content serving system 302, the eCommerce entity 304 can generate an iFrame component (e.g., as illustrated by arrow 338) and provide the iFrame component to the user device 310 (e.g., as illustrated by arrow 340). For example, the iFrame component can be included (e.g., as a hidden iFrame component) in a transaction confirmation web page that is provided to the user device 310. The iFrame component can include the token provided to the eCommerce entity 304 and a user/user device identifier associated with the user device 310. A domain of the iFrame component can be configured to be associated with a domain of the content serving system 302.

The content serving system 302 can use the generated iFrame component to receive the user/user device identifier along with the token (e.g., as illustrated by arrow 342). The content serving system 302 can store the user/user device identifier in association with the token (e.g., as illustrated by arrow 344), such as in a user-token log. The content serving system 302 can determine a linking between impressions and conversions based on the token, the transaction log, and the user-token log (e.g., as illustrated by arrow 346). For example, the content serving system 302 can use the token to determine a relevant user identifier and transaction details, and use the determined relevant user identifier to locate prior impressions made to the user (e.g., in the impression log, such as including the impression associated with the content item provided by the content sponsor 308).

When a linking impression and conversion are located, the content serving system 302 can credit the publisher that published the impression (e.g., the publisher 312), as illustrated by arrow 348. The content serving system 302 can credit the eCommerce entity that provided the transaction information (e.g., the eCommerce entity 304), as illustrated by arrow 350. The content serving system 302 can debit the content sponsor associated with the prior impression (e.g., the content sponsor 308), as illustrated by arrow 352.

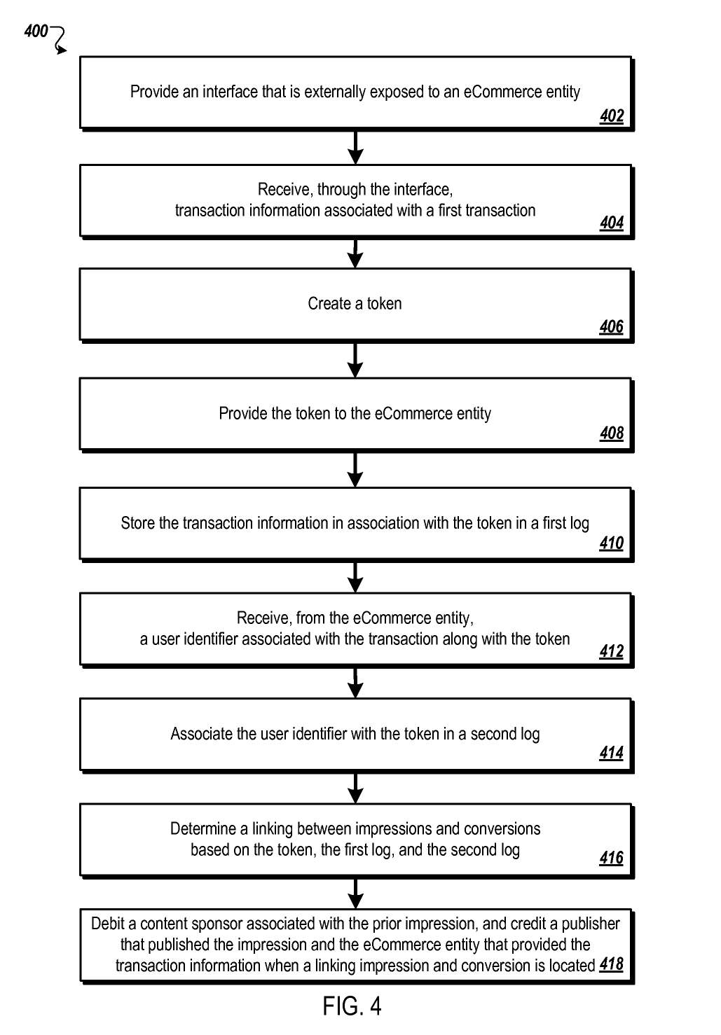

FIG. 4 is a flowchart of an example process 400 for crediting an entity for a conversion. The process 400 can be performed, for example, by the content management system 110 described above with respect to FIG. 1 and/or the content server 208 described above with respect to FIG. 2.

An interface is provided that is externally exposed to an eCommerce entity (402). The interface can be, for example, an API. The interface can be configured to receive transaction information associated with transactions by entities with the eCommerce entity that are known to a content serving system. For example, the transaction information can be associated with transactions performed by users and/or user devices known to the content serving system.

Transaction information associated with a first transaction is received through the interface (404). The transaction information can include, for example, a transaction date/time, a transaction amount, information describing purchased products or services, and/or other information.

A token is created (406). The token can be, for example, an identifier that has a value that is different from values of other tokens.

The token is provided to the entity (e.g., the eCommerce entity) (408). For example, the token can be provided as a value that is returned, using the interface, to the eCommerce entity in response to receipt of the transaction information.

The transaction information is stored in association with the token in a first log (410). The transaction information can be, for example, keyed by the token.

A user identifier associated with the transaction is received from the entity along with the token (412). For example, the user identifier (e.g., a cookie) can be received as a result of an iFrame being generated as part of the transaction. The iFrame can be associated with a domain of the content serving system. The identifier can be received in response to the iFrame being presented in association with the transaction.

The user identifier is associated with the token in a second log (414). For example, an entry can be added to the second log that includes the user identifier and the token. The entry can have one or more associated keys. For example, the keys can include one or more of the user identifier, the token, and/or a combination of the user identifier and the token.

A linking between impressions and conversions is determined based on the token, the first log, and the second log (416). The token can be used to determine a relevant user identifier and transaction details. The determined relevant user identifier can be used to locate prior impressions made to the user. For example, one or more impressions of content can be located that have been made prior to a time associated with the transaction to a user associated with the relevant user identifier. For example, a log of impressions can be queried. The log can include user identifier information for entities that were presented content, and information describing the presented content. The information describing the presented content can include, for example, brand information.

Transaction information can be identified, such as by querying the first log using the token. The located impression(s) and the transaction information can be evaluated to determine that the transaction information is related to one or more of the located impression(s). For example, a brand associated with an impression can be determined and a determination can be made that the brand is associated with products or services included in the transaction information. As another example, a brand associated with a product or service that is part of the transaction can be determined and one or more of the located impression(s) that relate to the brand can be identified.

A content sponsor associated with the prior impression is debited and a publisher that published the impression and the eCommerce entity that provided the transaction information are credited when a linking impression and conversion is located (418). The crediting and/or debiting can occur on a periodic (e.g., daily, weekly, monthly) basis, or in real time in response to the locating of the linking impression(s) and conversion.

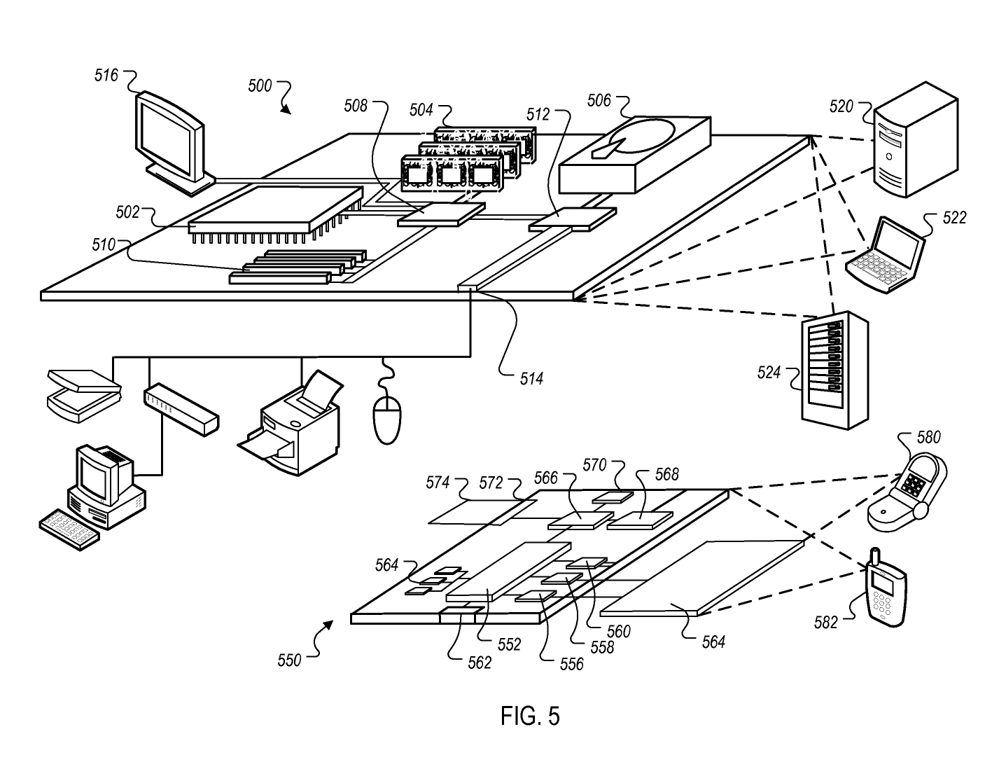

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth®, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
providing an interface that is externally exposed to an eCommerce entity, the interface being configured to receive transaction information associated with transactions by entities with the eCommerce entity that are known to a content serving system;
receiving through the interface transaction information associated with a first transaction;
creating a token;
providing the token to the eCommerce entity;
storing the transaction information in association with the token in a first log;
receiving from the eCommerce entity a user identifier associated with the transaction along with the token;
associating the user identifier with the token in a second log;
determining a linking between impressions and conversions based on the token, the first log, and the second log including using the token to determine a relevant user identifier and transaction details, and using the determined relevant user identifier to locate prior impressions made to the user; and
debiting a content sponsor associated with the prior impression and crediting a publisher that published the impression, and the eCommerce entity that provided the transaction information when a linking impression and conversion is located.

2. The method of claim 1 wherein providing the interface includes providing an API.

3. The method of claim 1 wherein the user identifier is received as a result of an iFrame being generated as part of the transaction, the iFrame being associated with a domain of the content serving system.

4. The method of claim 1 wherein receiving the user identifier includes receiving a cookie responsive to an iFrame being presented in association with the transaction.

5. The method of claim 1 further comprising identifying prior impressions for the relevant user identifier including locating one or more impressions of content that have been made prior to a time associated with the transaction to a user associated with the relevant user identifier; identifying transaction information for the transaction based on the token and the first log, and evaluating the one or more impressions and transaction information to determine that they are related.

6. The method of claim 5 wherein evaluating the one or more impressions and transaction information further includes determining a brand associated with the impression and determining that the brand is associated with products or services identified in the transaction information.

7. The method of claim 5 wherein evaluating includes determining a brand associated with a product or service that is part of the transaction and locating one or more impressions that relate to the brand.

8. The method of claim 1 further comprising providing a log of impressions, the log including user identifier information for entities that were presented content, and information describing the content presented.

9. The method of claim 8 wherein the information describing the presented content includes brand information.

10. The method of claim 1 further including receiving bids from content sponsors for conversions based on an initial brand impression, and storing the bids in an inventory.

11. The method of claim 10 further comprising receiving requests for content and serving brand impressions from the inventory responsive to the received request without debiting a content sponsor associated with a respective brand impression until a subsequent conversion is determined to have occurred based on the determined linking.

12. A system comprising:
one or more processors; and
one or more memory elements including instructions that when executed cause the one or more processors to:
provide an interface that is externally exposed to an eCommerce entity, the interface being configured to receive transaction information associated with transactions by entities with the eCommerce entity that are known to a content serving system;
receive through the interface transaction information associated with a first transaction;
create a token;
provide the token to the eCommerce entity;
store the transaction information in association with the token in a first log;
receive from the eCommerce entity a user identifier associated with the transaction along with the token;
associate the user identifier with the token in a second log;
determine a linking between impressions and conversions based on the token, the first log, and the second log including using the token to determine a relevant user identifier and transaction details, and using the determined relevant user identifier to locate prior impressions made to the user; and
debit a content sponsor associated with the prior impression and crediting a publisher that published the impression, and the eCommerce entity that provided the transaction information when a linking impression and conversion is located.

13. The system of claim 12, wherein providing the interface includes providing an API.

14. The system of claim 12 wherein the user identifier is received as a result of an iFrame being generated as part of the transaction, the iFrame being associated with a domain of the content serving system.

15. The system of claim 12 wherein receiving the user identifier includes receiving a cookie responsive to an iFrame being presented in association with the transaction.

16. The system of claim 12 wherein the information describing the presented content includes brand information.

17. A computer program product tangibly embodied in a computer-readable storage device and comprising instructions that, when executed by a processor, cause the processor to:
provide an interface that is externally exposed to an eCommerce entity, the interface being configured to receive transaction information associated with transactions by entities with the eCommerce entity that are known to a content serving system;
receive through the interface transaction information associated with a first transaction;
create a token;
provide the token to the eCommerce entity;
store the transaction information in association with the token in a first log;
receive from the eCommerce entity a user identifier associated with the transaction along with the token;
associate the user identifier with the token in a second log;
determine a linking between impressions and conversions based on the token, the first log, and the second log including using the token to determine a relevant user identifier and transaction details, and using the determined relevant user identifier to locate prior impressions made to the user; and
debit a content sponsor associated with the prior impression and crediting a publisher that published the impression, and the eCommerce entity that provided the transaction information when a linking impression and conversion is located.

18. The product of claim 17, wherein providing the interface includes providing an API.

19. The product of claim 17 wherein the user identifier is received as a result of an iFrame being generated as part of the transaction, the iFrame being associated with a domain of the content serving system.

20. The product of claim 17 wherein receiving the user identifier includes receiving a cookie responsive to an iFrame being presented in association with the transaction.
